(19) United States
(12) Patent Application Publication
(10) Pub. No.: US 2010/0072248 A1
(43) Pub. Date: Mar. 25, 2010

(54) NAILING FORCE-ADJUSTING DEVICE FOR A PNEUMATIC NAIL GUN

(75) Inventors: Chun-Chi Lai, Taichung (TW); Jin-Chi Chen, Taichung (TW)

Correspondence Address: DARBY & DARBY P.C., P.O. BOX 770, Church Street Station, New York, NY, 10008-0770, US

(73) Assignee: Basso Industry Corp., Taichung (TW)

(21) Appl. No.: 12/233,744

(22) Filed: Sep. 19, 2008

(51) Int. Cl. B25C 1/04

(52) U.S. Cl. 227/130; 227/129

(57) ABSTRACT

A nailing force-adjusting device for a pneumatic nail gun includes: a valve seat including a sleeve member sleeved on a cylinder, inner and outer flanges dividing an air-storing space between the cylinder and a gun housing into front and rear storing halves, the sleeve member defining a fluid passage for fluid communication with the rear storing half, the inner flange being formed with a valve opening in fluid communication with the fluid passage; and a sealing body formed with an axial through-hole and rotatable between a blocking position, in which the valve opening is blocked by the sealing body, and an unblocking position, in which the axial through-hole communicates fluidly with the valve opening.

### BACKGROUND OF THE INVENTION

1. Field of the Invention

The invention relates to a nailing force-adjusting device for a pneumatic nail gun, more particularly to a nailing force-adjusting device having a valve seat with a valve opening blocked and unblocked by a sealing body to control fluid communication between front and rear storing halves of an air-storing space.

2. Description of the Related Art

FIG. 1 illustrates a conventional pneumatic nail gun including a gun housing 11 having a rear seat 115, a cylinder 14 defining a rear end opening 141 and a chamber therein and mounted in and cooperating with the gun housing 11 to define an air-storing space therebetween, a piston 16 mounted movably in the cylinder 14 to divide the chamber into front and rear chamber halves 145, 146, a nail-striking pin 162 extending outwardly of the cylinder 14 from the piston 16, an annular partitioning member 13 sleeved on the cylinder 14 and abutting sealingly against the gun housing 11 so as to divide the air-storing space into front and rear storing halves 113, 112, an annular valve 12 sleeved on the cylinder 14, secured to the gun housing 11, and defining a valve opening 121 in fluid communication with the front storing half 113, and a spring-loaded sealing seat 17 mounted in the gun housing 11 and movable between a closed position (see FIG. 1), in which the sealing seat 17 abuts sealingly against a rear end 142 of the cylinder 14, thereby preventing fluid communication between the rear storing half 112 and the rear chamber half 146 through the rear end opening 141, and an opened position (not shown), in which the sealing seat 17 is spaced apart from the rear end 142 of the cylinder 14, thereby permitting fluid communication between the rear storing half 112 and the rear chamber half 146 through the rear end opening 141 of the cylinder 14. The cylinder 14 is provided with a driven sleeve 15 sleeved thereon and formed with an engaging groove 151, and is formed with a front hole 141 for fluid communication with the valve opening 121. The cylinder 14 is rotatable relative to the gun housing 11 about an axis of the cylinder 14. An operating rod 18 extends through an arcuate hole 110 in the gun housing 11 and into the engaging groove 151 in the driven sleeve 15 for driving rotation of the cylinder 14 relative to the gun housing 11 so as to adjust an overlapping area between the front hole 141 and the valve opening 121. In use, when the pneumatic nail gun is triggered, high pressure air enters the rear storing half 112 of the air-storing space, which results in movement of the spring-loaded sealing seat 17 to the opened position, thereby permitting the high pressure air to enter the rear chamber half 146 from the rear storing half 112 through the rear end opening 141, which, in turn, results in fast frontward movement of the piston 16 so as to discharge a nail out of a barrel (not shown) through the nail-striking pin 162. During frontward movement of the piston 16, the air in the front chamber half 145 is compressed and is pushed into the front storing half 113 through the front hole 141 and the valve opening 121. After discharge of the nail, the pressure in the rear storing half 112 and the pressure in the rear chamber half 146 are gradually decreased, which results in movement of the spring-loaded sealing seat 17 to the closed position and rearward movement of the piston 16 to its original position due to a pressure difference between the pressure in the front chamber half 145 and the pressure in the rear chamber half 146. Note that when the spring-loaded sealing seat 17 is disposed at the closed position, the rear chamber half 146 is in fluid communication with the outside environment through a passage (A), and when the spring-loaded sealing seat 17 is moved to the opened position, a contact surface (c) of the spring-loaded sealing seat 17 is brought into sealing contact with a contact surface (B) of the rear seat 115 to close the passage (A). Since the overlapping area between the front hole 141 and the valve opening 121 forms a constriction for the air flow from the front chamber half 145 to the front storing half 113, a back pressure is formed in the front chamber half 145 and offsets a portion of the pressure in the rear chamber half 146 when the piston 16 is moved frontwardly by the high pressure air. As such, adjustment in the overlapping area between the front hole 141 and the valve opening 121 through rotation of the cylinder 14 can adjust the back pressure and thus the nailing force for the pneumatic nail gun.

The conventional pneumatic nail gun is disadvantageous in that adjustment of the nailing force requires rotation of the cylinder 14 and that rotation of the cylinder 14 is relatively difficult due to its size and a tight contact between the cylinder 14 and each of the partitioning member 13 and the annular valve 12.

### SUMMARY OF THE INVENTION

The object of the present invention is to provide a nailing force-adjusting device for a pneumatic nail gun that can overcome the aforesaid drawbacks associated with the prior art.

According to the present invention, there is provided a nailing force-adjusting device for a nail gun. The nail gun includes a gun housing, a cylinder, a piston, and a spring-loaded sealing seat. The cylinder is mounted in and cooperates with the gun housing to define an air-storing space therebetween, defines an axis and a chamber therein, has front and rear ends aligned with each other along the axis and a rear end opening at the rear end, and is formed with at least one front through-hole. The piston is disposed coaxially and movably in and is in sealing contact with the cylinder to divide the chamber into front and rear chamber halves. The rear chamber half is in fluid communication with the air-storing space through the rear end opening of the cylinder. The front through-hole in the cylinder is in fluid communication with the front chamber half. The spring-loaded sealing seat is mounted movably in the gun housing, is disposed coaxially and rearwardly of the cylinder, and is movable between a closed position, in which the spring-loaded sealing seat abuts sealingly against the rear end of the cylinder so as to close the rear end opening of the cylinder, thereby preventing fluid communication between the air-storing space and the rear chamber half through the rear end opening, and an opened position, in which the spring-loaded sealing seat is spaced apart from the rear end of the cylinder, thereby permitting fluid communication between the rear chamber half and the air-storing space through the rear end opening. The nailing force-adjusting device comprises: a valve seat including a sleeve member that is adapted to be sleeved on the cylinder, an annular inner flange that radiates inwardly from the sleeve member toward the cylinder to contact sealingly the cylinder, and an annular outer flange that radiates outwardly from the sleeve member toward the gun housing to contact sealingly the gun housing so as to divide the air-storing space into front and rear storing halves such that the front storing half is in fluid communication with the front chamber half through the front through-hole in the cylinder and that the rear storing half is in fluid communication with the rear chamber half through the rear end opening of the cylinder when the spring-loaded sealing seat is disposed at the opened position, the sleeve member extending axially and rearwardly from the inner and outer flanges to the rear end of the cylinder and defining at least one fluid passage that is adapted to be in fluid communication with the rear storing half of the air-storing space when the spring-loaded sealing seat is disposed at the opened position and that is adapted to be blocked by the spring-loaded sealing seat when the spring-loaded sealing seat is disposed at the closed position, the annular inner flange having front and rear sides and being formed with at least one valve opening extending through the front and rear sides and in fluid communication with the fluid passage; and a sealing body adapted to be sleeved rotatably on the cylinder, having a rear side that is in sealing contact with the front side of the inner flange, and formed with at least one axial through-hole extending through the rear side of the sealing body and adapted to be in fluid communication with the front storing half of the air-storing space. The sealing body is rotatable about the axis relative to the valve seat between a blocking position, in which the valve opening is blocked by the rear side of the sealing body, thereby preventing air from flowing from the rear storing half into the front storing half of the air-storing space through the fluid passage, the valve opening and the axial through-hole, and an unblocking position, in which the axial through-hole is axially registered and communicates fluidly with the valve opening, thereby permitting air to flow from the rear storing half into the front storing half of the air-storing space through the fluid passage, the valve opening and the axial through-hole.

### BRIEF DESCRIPTION OF THE DRAWINGS

Other features and advantages of the present invention will become apparent in the following detailed description of the preferred embodiments with reference to the accompanying drawings, of which:

FIG. 1 is a partly sectional view of a conventional pneumatic nail gun;

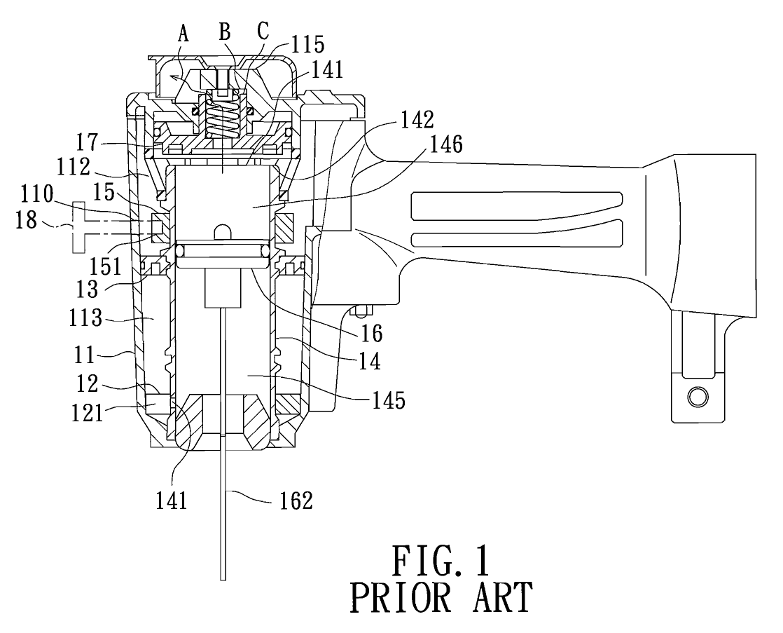

FIG. 2 is a fragmentary sectional view of the first preferred embodiment of a nailing force-adjusting device for a pneumatic nail gun according to this invention;

FIG. 3 is an exploded perspective view of the first preferred embodiment;

FIG. 4 is an assembled sectional view of the first preferred embodiment;

FIG. 5 is a partly sectional view of the first preferred embodiment, illustrating a state where a sealing body is moved to a blocking position by a driving member;

FIG. 6 is a partly sectional view of the first preferred embodiment, illustrating another state where the sealing body is moved to an unblocking position by the driving member;

FIG. 7 is a partly sectional view of the second preferred embodiment of the nailing force-adjusting device according to this invention, illustrating a state where a sealing body is moved to a blocking position by a driving member; and

FIG. 8 is a partly sectional view of the second preferred embodiment, illustrating another state where the sealing body is moved to an unblocking position by the driving member.

### DETAILED DESCRIPTION OF THE PREFERRED EMBODIMENTS

Before the present invention is described in greater detail with reference to the accompanying preferred embodiments, it should be noted here in that like elements are denoted by the same reference numerals throughout the disclosure.

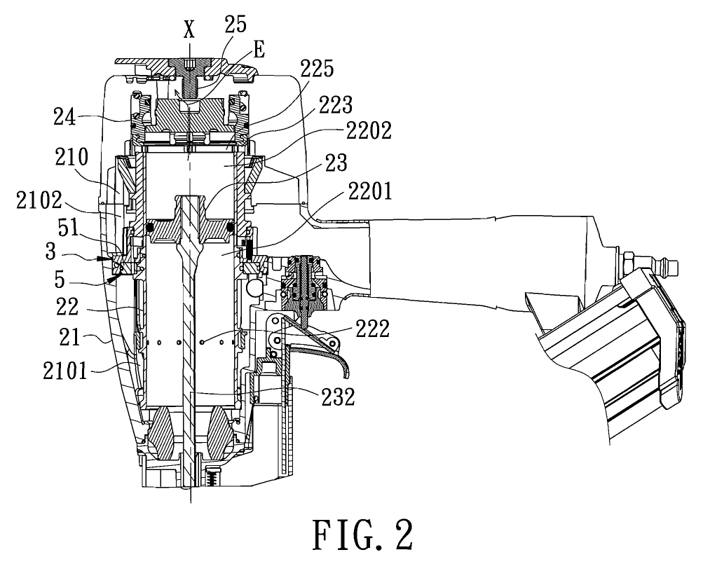

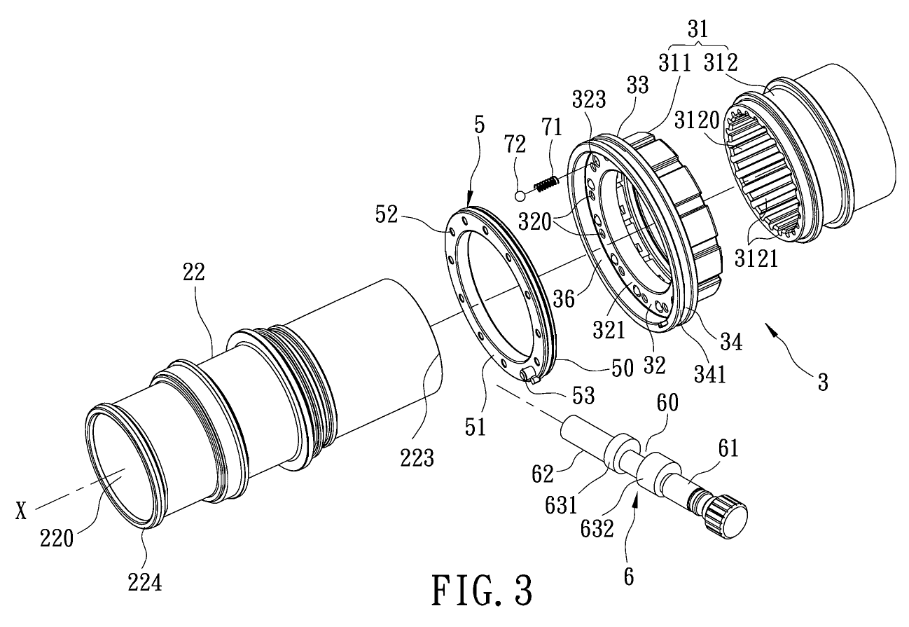

FIGS. 2 to 4 illustrate the first preferred embodiment of a nailing force-adjusting device for a pneumatic nail gun according to the present invention. The pneumatic nail gun includes a gun housing 21, a cylinder 22, a piston 23, a spring-loaded sealing seat 24, a rear plug 25, and a nailing force-adjusting device. The cylinder 22 is mounted in and cooperates with the gun housing 21 to define an air-storing space 210 therebetween, defines an axis (X) and a chamber 220 therein, has front and rear ends 224, 223 aligned with each other along the axis (X) and a rear end opening 225 at the rear end 223, and is formed with a plurality of front through-holes 222. The piston 23 is disposed coaxially and movably in and is in sealing contact with the cylinder 22 to divide the chamber 220 into front and rear chamber halves 2201, 2202. A nail-striking pin 232 is connected securely to the piston 23 and extends outwardly of the cylinder 22. The rear chamber half 2202 is in fluid communication with the air-storing space 210 through the rear end opening 225 of the cylinder 22. The front through-holes 222 in the cylinder 22 are in fluid communication with the front chamber half 2201. The spring-loaded sealing seat 24 is mounted movably in the gun housing 21, is disposed coaxially and rearwardly of the cylinder 22, has a rear recess 242, and is movable between a closed position (see FIG. 2), in which the spring-loaded sealing seat 24 abuts sealingly against the rear end 223 of the cylinder 22 so as to close the rear end opening 225 of the cylinder 22, thereby preventing fluid communication between the air-storing space 210 and the rear chamber half 2202 through the rear end opening 225, and an opened position (not shown), in which the spring-loaded sealing seat 24 is spaced apart from the rear end 223 of the cylinder 22, thereby permitting fluid communication between the rear chamber half 2202 and the air-storing space 210 through the rear end opening 225. Note that the rear chamber half 2202 is in fluid communication with the outside environment through a passage (E) (see FIG. 2) when the spring-loaded sealing seat 24 is disposed at the closed position. The passage (E) is closed by extension of the rear plug 25 into the rear recess 242 in the spring-loaded sealing seat 24 when the spring-loaded sealing seat 24 is moved toward the rear plug 25 to the opened position.

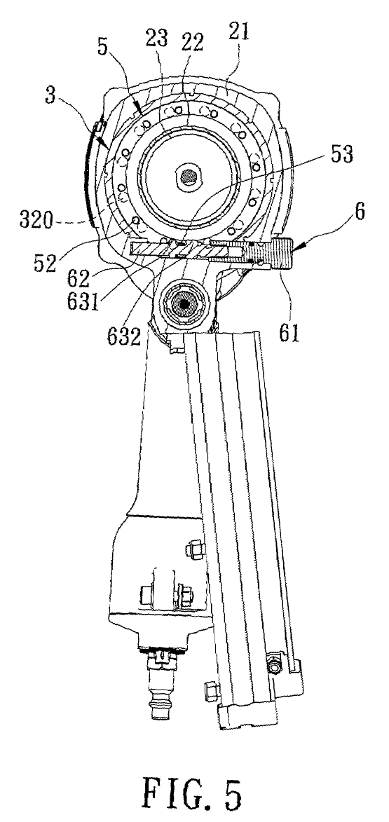

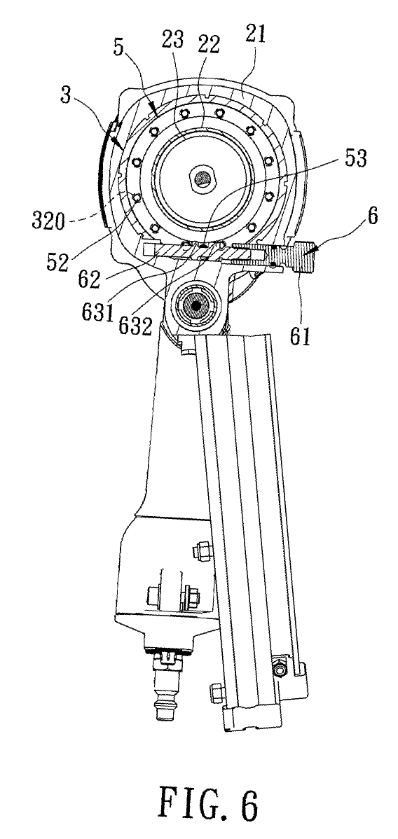

The nailing force-adjusting device includes: a valve seat 3 including a sleeve member 31 that is sleeved on the cylinder 22, an annular inner flange 32 that radiates inwardly from the sleeve member 31 toward the cylinder 22 to contact sealingly the cylinder 22, and an annular outer flange 33 radiating outwardly from the sleeve member 31 toward the gun housing 21 to contact sealingly the gun housing 21 so as to divide the air-storing space 210 into front and rear storing halves 2101, 2102 such that the front storing half 2101 is in fluid communication with the front chamber half 2201 through the front through-holes 222 in the cylinder 22 and that the rear storing half 2102 is in fluid communication with the rear chamber half 2202 through the rear end opening 225 of the cylinder 22 when the spring-loaded sealing seat 24 is disposed at the opened position, the sleeve member 31 extending axially and rearwardly from the inner and outer flanges 32, 33 to the rear end 223 of the cylinder 22 and defining a plurality of fluid passages 310 that are in fluid communication with the rear storing half 2102 of the air-storing space 210 when the spring-loaded sealing seat 24 is disposed at the opened position and that are blocked by the spring-loaded sealing seat 24 when the spring-loaded sealing seat 24 is disposed at the closed position, the annular inner flange 32 having front and rear sides 321, 322 and being formed with a plurality of valve openings 320 extending through the front and rear sides 321, 322 and in fluid communication with the fluid passages 310, respectively; and a sealing body 5 sleeved rotatably on the cylinder 2, having a front side 51 and a rear side 50 that is opposite to the rear side 50 of the sealing body 5 in an axial direction with respect to the axis (X) and that is in sealing contact with the front side 321 of the inner flange 32, and formed with a plurality of axial through-holes 52 extending through the front and rear sides 51, 50 of the sealing body 5 and in fluid communication with the front storing half 2101 of the air-storing space 210. The sealing body 5 is rotatable about the axis (X) relative to the valve seat 3 between a blocking position (see FIG. 5), in which the valve openings 320 are blocked by the rear side 50 of the sealing body 5, thereby preventing air from flowing from the rear storing half 2102 into the front storing half 2101 of the air-storing space 210 through the fluid passages 310, the valve openings 320 and the axial through-holes 52, and an unblocking position (see FIG. 6), in which the axial through-holes 52 are axially registered and communicate fluidly with the valve openings 320, thereby permitting air to flow from the rear storing half 2102 into the front storing half 2101 of the air-storing space 210 through the fluid passages 310, the valve openings 320 and the axial through-holes 52. It is noted that modifications can be made for the preferred embodiment such that each of the axial through-holes 52 can be partially or fully registered with the respective one of the valve openings 320 by rotating the sealing body 5 to a corresponding one of different predetermined angular positions for adjusting the nailing force, i.e., the nailing force can be adjusted by adjusting an overlapping area between a radial size of each of the axial through-holes 52 and a radial size of the respective one of the valve openings 320.

In this embodiment, the sleeve member 31 includes a connecting part 311 extending axially and rearwardly from the inner and outer flanges 32, 33 and defining an inner space 313 for extension of the cylinder 22 therethrough, and a sleeve part 312 connected to the connecting part 311, sleeved on the cylinder 22, extending to the rear end 223 of the cylinder 22, and having an inner side 3120 that contacts the cylinder 22 and that is formed with a plurality of axially extending grooves 3121. Each of the axially extending grooves 3101 cooperates with a portion 3131 of the inner space 313 in the connecting part 311, which is disposed around the cylinder 22, to define a respective one of the fluid passages 310.

The valve seat 3 further includes an annular wall 34 extending axially and frontwardly from a periphery of the outer flange 33 and cooperating with the inner and outer flanges 32, 33 to define an accommodating recess 36 thereamong. The sealing body 5 is in the form of a ring-shaped plate that is fitted rotatably into the accommodating recess 36. The annular wall 34 has an enlarged front end 341 that is in sealing contact with the gun housing 21.

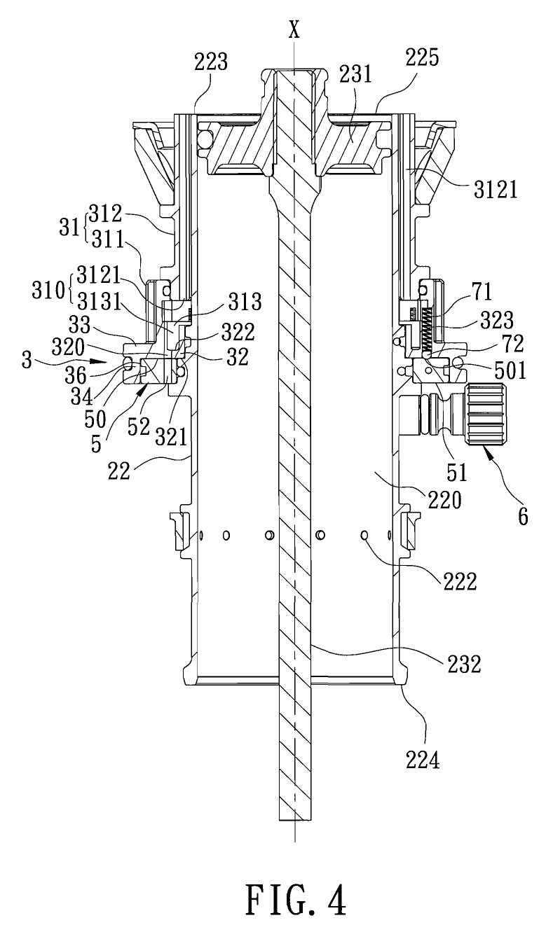

The inner flange 32 is further formed with a plurality of spring holes 323 extending axially through the front side 321 of the inner flange 32. The valve seat 3 further includes a plurality of urging members 71 disposed in the spring holes 323, respectively, and a plurality of engaging balls 72 received in the spring holes 323 and urged by the urging members 71 to protrude outwardly of the spring holes 323, respectively. The sealing body 5 is further formed with a plurality of concave recesses 501 (only one is shown in FIG. 4), each of which is indented from the rear side 50 of the sealing body 5 and is defined by a recess-defining wall. The engaging balls 72 protrude into the concave recesses 501, and are in sliding contact with the recess-defining walls, respectively, when the sealing body 5 is disposed at the unblocking position (see FIG. 4).

The nailing force-adjusting device further includes a driving member 6 extending sealingly and movably into the gun housing 21, defining an engaging groove 60, and movable relative to the valve seat 3 in a transverse direction relative to the axis (X). The sealing body 5 further has a driven protrusion 53 protruding axially from the front side 51 of the sealing body 5 into the engaging groove 60 to engage the driving member 6 so as to permit the sealing body 5 to be driven by the driving member 6 to rotate about the axis (X) between the blocking and unblocking positions when the driving member 6 is moved back and forth in the transverse direction.

In this embodiment, the driving member 6 includes a threaded rod 62 disposed in the gun housing 21, first and second annular flanges 631, 632 radiating outwardly from the threaded rod 62 and spaced apart from each other by a gap that defines the engaging groove 60, and a driving screw nut 61 engaging threadedly the threaded rod 62 so as to drive the threaded rod 62 to move in the transverse direction upon rotation thereof, and extending outwardly of the gun housing 21 for operation.

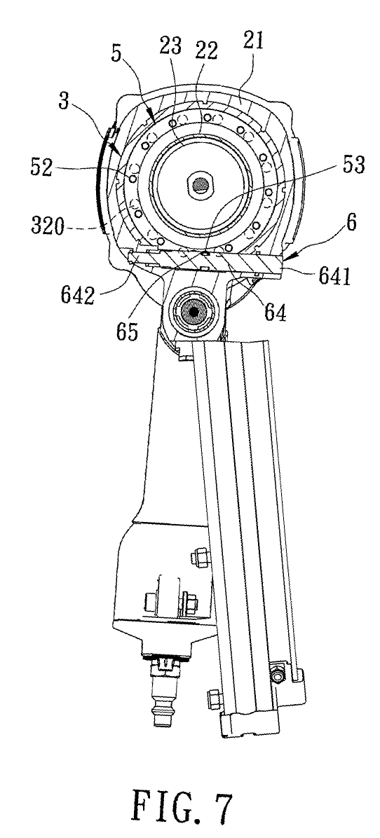

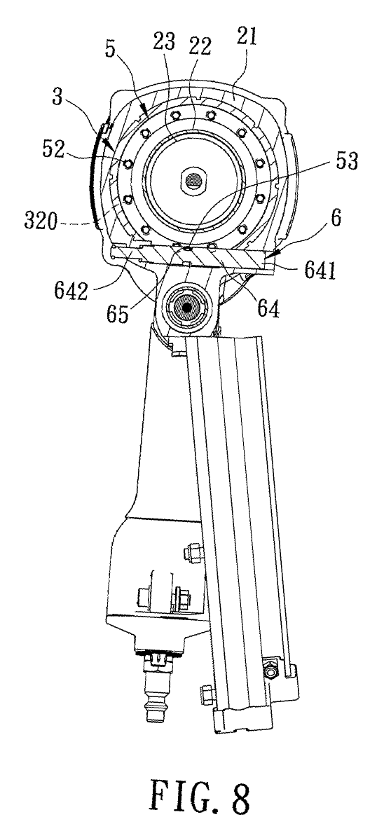

FIGS. 7 and 8 illustrate the second preferred embodiment of the nailing force-adjusting device according to this invention. The second preferred embodiment differs from the previous embodiment in that the driving member 6 includes a driving rod 64 extending into a guiding groove in the gun housing 21 and formed with an indent 65 that defines the engaging groove 60. The driving rod 64 is slidable along the guiding groove and has opposite first and second ends 641, 642 exposed and accessible from two opposite sides of the gun housing 21 so as to facilitate operation of the driving member 6 to move back-and-forth along the guiding groove through the first and second ends 641, 642 and so as to drive the sealing body 5 to rotate between the blocking position (see FIG. 7) and the unblocking position (see FIG. 8).

In use, when a maximum nailing force is to be used, the sealing body 5 is moved to the blocking position (see FIG. 5). As such, when the pneumatic nail gun is triggered, high pressure air is injected into the rear storing half 2102 of the air-storing space 210 and pushes the spring-loaded sealing seat 24 to move to the opened position, thereby permitting the high pressure air to enter the rear chamber half 2202 from the rear storing half 2102, which results in fast frontward movement of the piston 23 together with the nail-striking pin 232 to discharge a nail (not shown) out of a barrel (not shown). Note that since the valve openings 320 are blocked by the sealing body 5, fluid communication between the rear storing half 2102 and the front storing half 2101 is not allowed at this time. During frontward movement of the piston 23 in the cylinder 22, the air inside the front chamber half 2201 is compressed and is pushed into the front storing half 2101 of the air-storing half 210. After discharge of the nail, the pressure in the rear storing half 2102 and the pressure in the rear chamber half 2202 are gradually decreased, which results in movement of the spring-loaded sealing seat 24 to the closed position and in rearward movement of the piston 23 to its original position due to a pressure difference between the pressure in the front chamber half 2201 and the pressure in the rear chamber half 2202. On the other hand, when a minimum nailing force is to be used, the sealing body 5 is moved to the unblocking position (see FIG. 6). As such, when the pneumatic nail gun is triggered, the high pressure air is injected into the rear storing half 2102 of the air-storing space 210 and pushes the spring-loaded sealing seat 24 to move to the opened position. Since the rear storing half 2102 is now in fluid communication with the front storing half 2101 through the axial through-holes 52, the valve openings 320 and the fluid passages 310, a portion of the high pressure air in the rear storing half 2102 enters the front storing half 2101, and the remainder of the high pressure air enters the rear chamber half 2202 for pushing the piston 23 to drive the nail out of the barrel. As a consequence, the nailing force is decreased in an amount corresponding to the amount of the high pressure air that enters the front storing half 2101 of the air-storing space 210.

With the inclusion of the valve seat 3 and the sealing body 5 in the nailing force-adjusting device of the pneumatic nail gun of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A nailing force-adjusting device for a pneumatic nail gun, the pneumatic nail gun including a gun housing, a cylinder, a piston, and a spring-loaded sealing seat, the cylinder being mounted in and cooperating with the gun housing to define an air-storing space therebetween, defining an axis and a chamber therein, having front and rear ends aligned with each other along the axis and a rear end opening at the rear end, and being formed with at least one front through-hole, the piston being disposed coaxially and movably in and in sealing contact with the cylinder to divide the chamber into front and rear chamber halves, the rear chamber half being in fluid communication with the air-storing space through the rear end opening of the cylinder, the front through-hole in the cylinder being in fluid communication with the front chamber half, the spring-loaded sealing seat being mounted movably in the gun housing, being disposed coaxially and rearwardly of the cylinder, and being movable between a closed position, in which the spring-loaded sealing seat abuts sealingly against the rear end of the cylinder so as to close the rear end opening of the cylinder, thereby preventing fluid communication between the air-storing space and the rear chamber half through the rear end opening, and an opened position, in which the spring-loaded sealing seat is spaced apart from the rear end of the cylinder, thereby permitting fluid communication between the rear chamber half and the air-storing space through the rear end opening, said nailing force-adjusting device comprising:
a valve seat including a sleeve member that is adapted to be sleeved on the cylinder, an annular inner flange that radiates inwardly from said sleeve member toward the cylinder to contact sealingly the cylinder, and an annular outer flange that radiates outwardly from said sleeve member toward the gun housing to contact sealingly the gun housing so as to divide the air-storing space into front and rear storing halves such that the front storing half is in fluid communication with the front chamber half through the front through-hole in the cylinder and that the rear storing half is in fluid communication with the rear chamber half through the rear end opening of the cylinder when the spring-loaded sealing seat is disposed at the opened position, said sleeve member extending axially and rearwardly from said inner and outer flanges to the rear end of the cylinder and defining at least one fluid passage that is adapted to be in fluid communication with the rear storing half of the air-storing space when the spring-loaded sealing seat is disposed at the opened position and that is adapted to be blocked by the spring-loaded sealing seat when the spring-loaded sealing seat is disposed at the closed position, said annular inner flange having front and rear sides and being formed with at least one valve opening extending through said front and rear sides and in fluid communication with said fluid passage; and
a sealing body adapted to be sleeved rotatably on the cylinder, having a rear side that is in sealing contact with said front side of said inner flange, and formed with at least one axial through-hole extending through said rear side of said sealing body and adapted to be in fluid communication with the front storing half of the air-storing space;
wherein said sealing body is rotatable about the axis relative to said valve seat between a blocking position, in which said valve opening is blocked by said rear side of said sealing body, thereby preventing air from flowing from the rear storing half into the front storing half of the air-storing space through said fluid passage, said valve opening and said axial through-hole, and an unblocking position, in which said axial through-hole is axially registered and communicates fluidly with said valve opening, thereby permitting air to flow from the rear storing half into the front storing half of the air-storing space through said fluid passage, said valve opening and said axial through-hole.

2. The nailing force-adjusting device as claimed in claim 1, wherein said sleeve member includes a connecting part extending axially and rearwardly from said inner and outer flanges and defining an inner space adapted for extension of the cylinder therethrough, and a sleeve part connected to said connecting part, adapted to be sleeved on the cylinder and to extend to the rear end of the cylinder, and having an inner side that is adapted to contact the cylinder and that is formed with at least one axially extending groove, said axially extending groove cooperating with a portion of said inner space in said connecting part, which is disposed around the cylinder, to define said fluid passage.

3. The nailing force-adjusting device as claimed in claim 2, wherein said valve seat further includes an annular wall extending axially and frontwardly from said outer flange and cooperating with said inner and outer flanges to define an accommodating recess thereamong, said sealing body being in the form of a ring-shaped plate that is fitted rotatably into said accommodating recess.

4. The nailing force-adjusting device as claimed in claim 1, wherein said inner flange is further formed with at least one spring hole extending axially through said front side of said inner flange, said valve seat further including at least one urging member disposed in said spring hole, and at least one engaging ball received in said spring hole and urged by said urging member to protrude outwardly of said spring hole, said sealing body being further formed with at least one concave recess indented from said rear side of said sealing body and defined by a recess-defining wall, said engaging ball protruding into said concave recess and being in sliding contact with said recess-defining wall when said sealing body is disposed at the unblocking position.

5. The nailing force-adjusting device as claimed in claim 1, further comprising a driving member adapted to extend sealingly and movably into the gun housing, defining an engaging groove, and movable relative to said valve seat in a transverse direction relative to the axis, said sealing body further having a front side opposite to said rear side of said sealing body in an axial direction with respect to the axis, and a driven protrusion protruding axially from said front side of said sealing body into said engaging groove to engage said driving member so as to permit said sealing body to be driven by said driving member to rotate about the axis between the blocking and unblocking positions when said driving member is moved back and forth in the transverse direction.

6. The nailing force-adjusting device as claimed in claim 5, wherein said driving member includes a threaded rod adapted to be disposed in the gun housing, first and second annular flanges radiating outwardly from said threaded rod and spaced apart from each other by a gap that defines said engaging groove, and a driving screw nut that engages threadedly said threaded rod so as to drive said threaded rod to move in the transverse direction upon rotation thereof and that is adapted to extend outwardly of the gun housing.

7. The nailing force-adjusting device as claimed in claim 5, wherein said driving member includes a driving rod adapted to extend into the gun housing and formed with an indent that defines said engaging groove.

8. A pneumatic nail gun comprising:
a gun housing;
a cylinder mounted in and cooperating with said gun housing to define an air-storing space therebetween, defining an axis and a chamber therein, having front and rear ends aligned with each other along the axis and a rear end opening at said rear end, and formed with at least one front through-hole;
a piston disposed coaxially and movably in and in sealing contact with said cylinder to divide said chamber into front and rear chamber halves, said rear chamber half being in fluid communication with said air-storing space through said rear end opening of said cylinder, said front through-hole in said cylinder being in fluid communication with said front chamber half;
a spring-loaded sealing seat mounted movably in said gun housing, disposed coaxially and rearwardly of said cylinder, and movable between a closed position, in which said spring-loaded sealing seat abuts sealingly against said rear end of said cylinder so as to close said rear end opening of said cylinder, thereby preventing fluid communication between said air-storing space and said rear chamber half through said rear end opening, and an opened position, in which said spring-loaded sealing seat is spaced apart from said rear end of said cylinder, thereby permitting fluid communication between said rear chamber half and said air-storing space through said rear end opening; and
a nailing force-adjusting device including
a valve seat including a sleeve member that is sleeved on said cylinder, an annular inner flange that radiates inwardly from said sleeve member toward said cylinder to contact sealingly said cylinder, and an annular outer flange radiating outwardly from said sleeve member toward said gun housing to contact sealingly said gun housing so as to divide said air-storing space into front and rear storing halves such that said front storing half is in fluid communication with said front chamber half through said front through-hole in said cylinder and that said rear storing half is in fluid communication with said rear chamber half through said rear end opening of said cylinder when said spring-loaded sealing seat is disposed at the opened position, said sleeve member extending axially and rearwardly from said inner and outer flanges to said rear end of said cylinder and defining at least one fluid passage that is in fluid communication with said rear storing half of said air-storing space when said spring-loaded sealing seat is disposed at the opened position and that is blocked by said spring-loaded sealing seat when said spring-loaded sealing seat is disposed at the closed position, said annular inner flange having front and rear sides and being formed with at least one valve opening extending through said front and rear sides and in fluid communication with said fluid passage, and
a sealing body sleeved rotatably on said cylinder, having a rear side that is in sealing contact with said front side of said inner flange, and formed with at least one axial through-hole extending through said rear side of said sealing body and in fluid communication with said front storing half of said air-storing space;
wherein said sealing body is rotatable about the axis relative to said valve seat between a blocking position, in which said valve opening is blocked by said rear side of said sealing body, thereby preventing air from flowing from said rear storing half into said front storing half of said air-storing space through said fluid passage, said valve opening and said axial through-hole, and an unblocking position, in which said axial through-hole is axially registered and communicates fluidly with said valve opening, thereby permitting air to flow from said rear storing half into said front storing half of said air-storing space through said fluid passage, said valve opening and said axial through-hole.

9. The pneumatic nail gun as claimed in claim 8, wherein said sleeve member includes a connecting part extending axially and rearwardly from said inner and outer flanges and defining an inner space for extension of said cylinder therethrough, and a sleeve part connected to said connecting part, sleeved on said cylinder, extending to said rear end of said cylinder, and having an inner side that contacts said cylinder and that is formed with at least one axially extending groove, said axially extending groove cooperating with a portion of said inner space in said connecting part, which is disposed around said cylinder, to define said fluid passage.

10. The pneumatic nail gun as claimed in claim 9, wherein said valve seat further includes an annular wall extending axially and frontwardly from said outer flange and cooperating with said inner and outer flanges to define an accommodating recess thereamong, said sealing body being in the form of a ring-shaped plate that is fitted rotatably into said accommodating recess.

11. The pneumatic nail gun as claimed in claim 8, wherein said inner flange is further formed with at least one spring hole extending axially through said front side of said inner flange, said valve seat further including at least one urging member disposed in said spring hole, and at least one engaging ball received in said spring hole and urged by said urging member to protrude outwardly of said spring hole, said sealing body being further formed with at least one concave recess indented from said rear side of said sealing body and defined by a recess-defining wall, said engaging ball protruding into said concave recess and being in sliding contact with said recess-defining wall when said sealing body is disposed at the unblocking position.

12. The pneumatic nail gun as claimed in claim 8, further comprising a driving member extending sealingly and movably into said gun housing, defining an engaging groove, and movable relative to said valve seat in a transverse direction relative to the axis, said sealing body further having a front side opposite to said rear side of said sealing body in an axial direction with respect to the axis, and a driven protrusion protruding axially from said front side of said sealing body into said engaging groove to engage said driving member so as to permit said sealing body to be driven by said driving member to rotate about the axis between the blocking and unblocking positions when said driving member is moved back and forth in the transverse direction.

13. The pneumatic nail gun as claimed in claim 12, wherein said driving member includes a threaded rod disposed in said gun housing, first and second annular flanges radiating outwardly from said threaded rod and spaced apart from each other by a gap that defines said engaging groove, and a driving screw nut that engages threadedly said threaded rod so as to drive said threaded rod to move in the transverse direction upon rotation thereof and that extends outwardly of said gun housing.

14. The pneumatic nail gun as claimed in claim 12, wherein said driving member includes a driving rod extending into said gun housing and formed with an indent that defines said engaging groove.
